(19) United States
(12) Patent Application Publication
(10) Pub. No.: US 2026/0330438 A1
(43) Pub. Date: Oct. 22, 2026

(54) SALES DATA PROCESSING APPARATUS, METHOD, AND STORAGE MEDIUM

(71) Applicant: Toshiba Tec Kabushiki Kaisha, Tokyo (JP)

(72) Inventor: Tomomitsu TAKAHASHI, Sunto Shizuoka (JP)

(21) Appl. No.: 19/467,722

(22) Filed: Feb. 2, 2026

(30) Foreign Application Priority Data
Mar. 26, 2025 (JP) 2025-051189

(51) Int. Cl. G06Q 20/20

(52) U.S. Cl. CPC G06Q 20/209; G06Q 20/208

(57) ABSTRACT

A sales data processing apparatus includes a first display device; a second display device; a printer; a housing having a cavity that is capable of removably accommodating the printer and is disposed on the same side as the first display device; and a support column that is disposed on an upper surface of the housing and supports the first display device and the second display device in a back-to-back arrangement.

### CROSS-REFERENCE TO RELATED APPLICATION

This application is based upon and claims the benefit of priority from Japanese Patent Application No. 2025-051189, filed Mar. 26, 2025, the entire contents of which are incorporated herein by reference.

### FIELD

Embodiments described herein relate generally to a sales data processing apparatus, a method, and a storage medium.

### BACKGROUND

With a semi-self-service point-of-sale (POS) terminal (or sales data processing apparatus), a store clerk and a customer face each other, the store clerk performs an item registration operation for registering items, and the customer performs a payment operation. Such a POS terminal generally includes a printer for printing a receipt or the like, and the printer may be installed to face the store clerk or the customer.

Whether the printer is installed to face the store clerk or the customer differs for each facility, such as a store. For this reason, it is preferable that a POS terminal be configured such that the printer can be selectively installed to face either the store clerk or the customer. Furthermore, depending on the facility, a POS terminal needs to be installed in a narrow space. Therefore, there is a demand for space saving of peripheral devices, such as a printer, of a POS terminal.

### SUMMARY OF THE INVENTION

Embodiments of the present disclosure make it possible to improve the convenience of printer installation.

According to an aspect of the present disclosure, a sales data processing apparatus comprises a first display device; a second display device; a printer; a housing having a cavity that is capable of removably accommodating the printer and is disposed on the same side as the first display device; and a support column that is disposed on an upper surface of the housing and supports the first display device and the second display device in a back-to-back arrangement.

### BRIEF DESCRIPTION OF THE DRAWINGS

FIG. 1 is a perspective view illustrating an external appearance of a POS terminal according to an embodiment.

FIG. 2 is a perspective view illustrating an external appearance of the POS terminal.

FIG. 3 is a side view illustrating an external appearance of the POS terminal.

FIG. 4 is a perspective view illustrating an external appearance of the POS terminal.

FIG. 5 is a perspective view illustrating an external appearance of the POS terminal.

FIG. 6 is a side view illustrating an external appearance of the POS terminal.

FIG. 7 is a diagram illustrating a storage case before being inserted into a housing cavity of the POS terminal according to the embodiment.

FIG. 8 is a diagram illustrating the storage case inserted into the housing cavity of the POS terminal.

FIG. 9 is a block diagram illustrating an example of a hardware configuration of the POS terminal.

FIG. 10 is a functional block diagram illustrating an example of a functional configuration of the POS terminal.

FIG. 11 is a flowchart illustrating an example of a process performed by the POS terminal.

FIG. 12 is a diagram illustrating an example of a display screen of a clerk-side display device.

FIG. 13 is a diagram illustrating an example of a display screen of a customer-side display device.

### DETAILED DESCRIPTION

Hereinafter, embodiments will be described in detail with reference to the drawings. In the embodiments, a POS terminal is described as an example of a sales data processing apparatus. However, the present disclosure is not limited to the embodiments described below. In addition, a Z axis in the drawings indicates the vertical direction of the POS terminal, a Y axis in the drawings indicates the longitudinal direction of the POS terminal, and an X axis in the drawings indicates the width direction of the POS terminal.

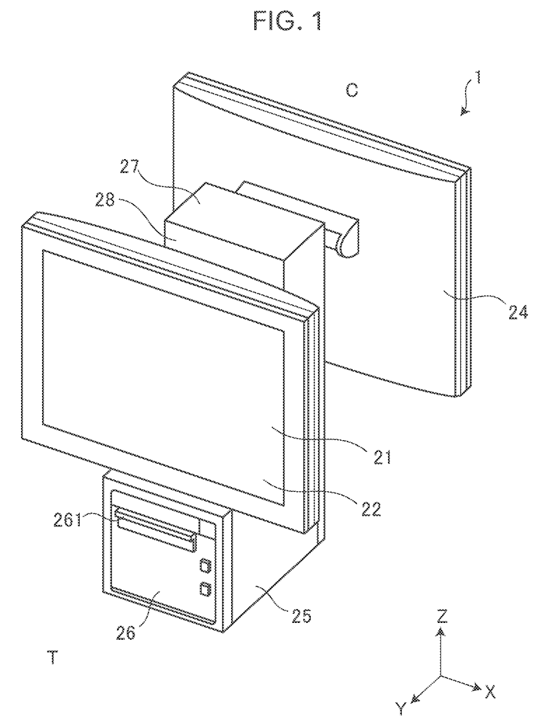

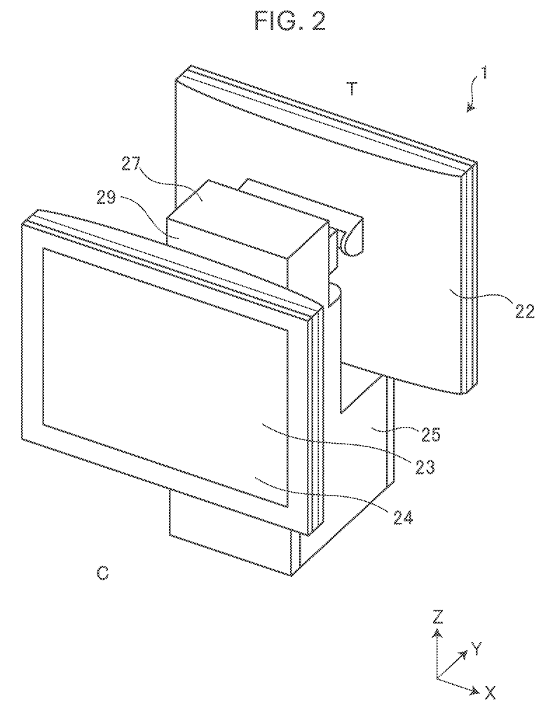

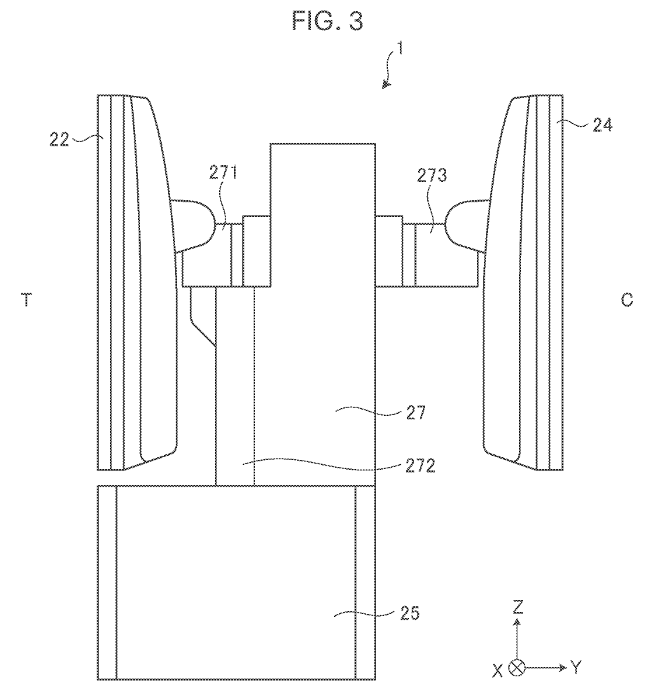

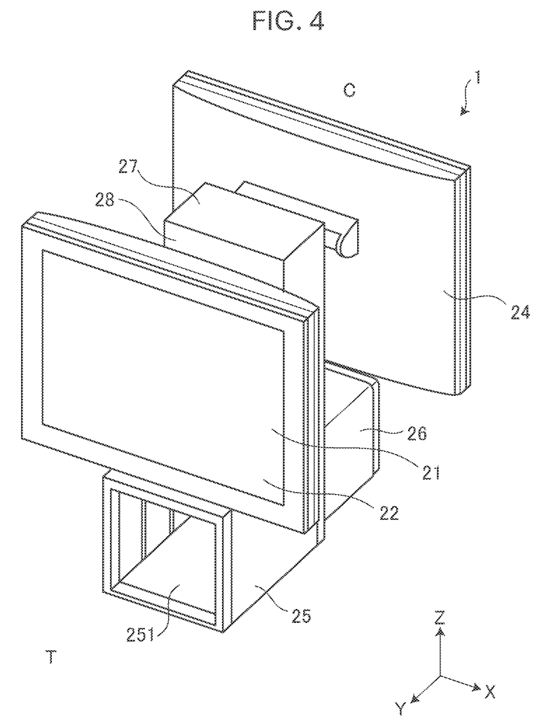

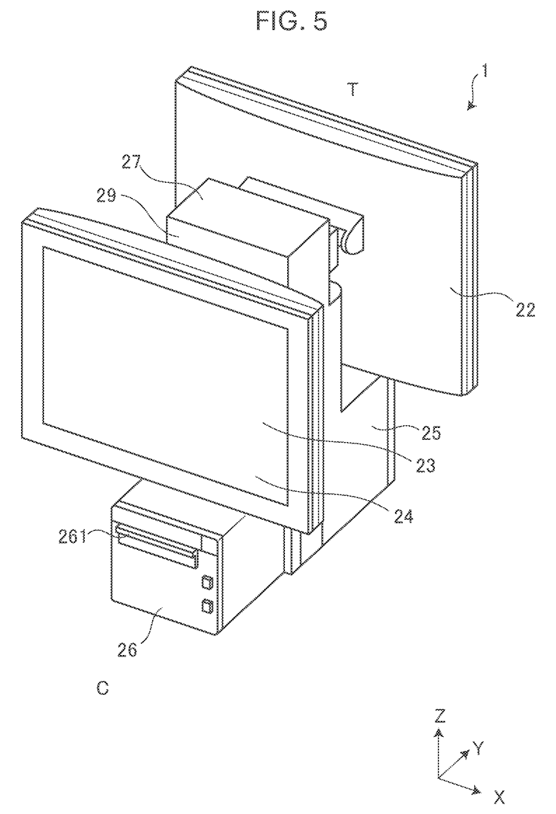

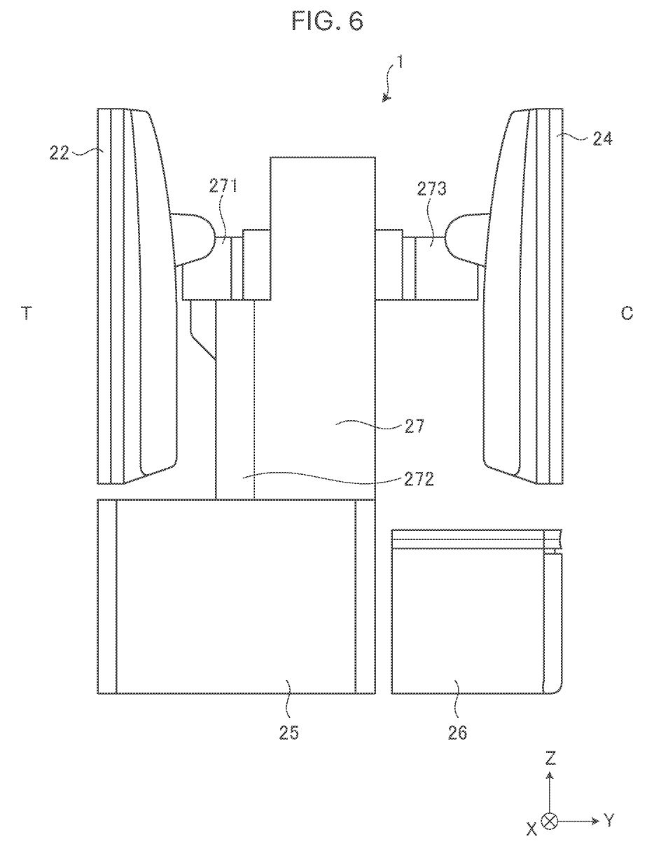

FIGS. 1 and 2 are perspective views illustrating an external appearance of a POS terminal 1 according to an embodiment. FIG. 3 is a side view illustrating an external appearance of the POS terminal 1 according to the embodiment. FIGS. 4 and 5 are perspective views illustrating an external appearance of the POS terminal 1 according to the embodiment. FIG. 6 is a side view illustrating an external appearance of the POS terminal 1 according to the embodiment.

With the POS terminal 1, a store clerk and a customer face each other, the store clerk performs an item registration operation, and the customer performs a payment operation.

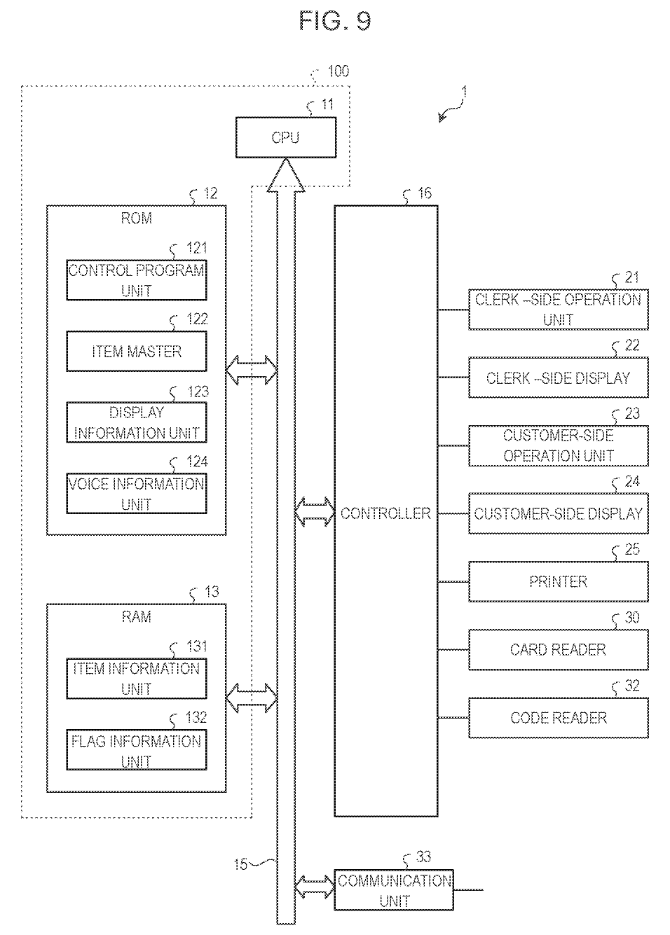

Here, the item registration operation refers to an operation of reading a code symbol, such as a barcode or a two dimensional code, attached to an item with a code reader 32 (for example, a scanner; see FIG. 9). In a case where the code reader 32 is a camera, the item registration operation may be an operation of causing the code reader 32 to capture an image of the item. The operation of capturing an image of the code symbol is also included in the operation of reading the code symbol, and is a type of an item registration operation.

For example, the POS terminal 1 is installed on a flat upper surface of a bagging counter (not shown). In FIGS. 1 and 4, the near side (T side) of the POS terminal 1 is to be oriented toward the store clerk and is referred to as a store-clerk side, and the far side (C side) of the POS terminal 1 is to be oriented toward the customer and is referred to as a customer side. In FIGS. 2 and 5, the near side (C side) corresponds to the customer side, and the far side (T side) corresponds to the store-clerk side.

The POS terminal 1 includes a housing 25. The housing 25 is an example of a base part. For example, the housing 25 is installed on the upper surface of the bagging counter. The configurations of the housing 25 and a printer 26 will be described later.

As shown in FIGS. 1 and 2, the POS terminal 1 includes an upright part 27 disposed on the upper surface of the housing 25. The upright part 27 is an example of a support column. The upright part 27 houses a control unit 100 (see FIG. 9), a controller 16 (see FIG. 9), a communication unit 33 (see FIG. 9), and the like.

A code reader 32 (see FIG. 9) may be provided inside the upright part 27. In this case, the upright part 27 may have a reading window through which the code reader 32 reads a code symbol attached to an item.

The POS terminal 1 also includes a clerk-side display 22 that is disposed on an upright surface 28 of the upright part 27 to be oriented toward the store clerk (T side). The clerk-side display 22 is an example of a first display device. The clerk-side display 22 is, for example, a liquid crystal display and displays information for the store clerk.

As shown in FIG. 1, a clerk-side operation unit 21 is provided on the display surface of the clerk-side display 22. The clerk-side operation unit 21 is implemented by, for example, a touch panel (or a first touch panel). As an example, the clerk-side display 22 displays various keys related to an item registration process, and the store clerk can operate the keys by touching the corresponding positions on the clerk-side operation unit 21.

The POS terminal 1 includes a customer-side display 24 that is disposed on an upright surface 29 of the upright part 27 to be oriented toward the customer (C side). The customer-side display 24 is an example of a second display device. The customer-side display 24 is, for example, a liquid crystal display and displays information for the customer.

As shown in FIG. 2, a customer-side operation unit 23 is provided on the display surface of the customer-side display 24. The customer-side operation unit 23 is implemented by, for example, a touch panel (or a second touch panel). As an example, the customer-side display 24 displays various keys related to a payment process, and the customer can operate the keys by touching the corresponding positions on the customer-side operation unit 23.

The upright part 27 includes a post 271, a first tilt mechanism 272, and a second tilt mechanism 273.

As shown in FIG. 3, the clerk-side display 22 is supported on the upper surface of the housing 25 by the post 271. The clerk-side display 22 can be tilted about an axis extending along the width direction (or X-axis direction) of the POS terminal 1 by the first tilt mechanism 272. The customer-side display 24 can be tilted about an axis extending along the width direction by the second tilt mechanism 273.

A post may also be provided for the customer-side display 24. In this case, the customer-side display 24 is supported on the upper surface of the housing 25 by the post.

Next, the housing 25 and the printer 26 will be described. The housing 25 accommodates the printer 26.

As shown in FIG. 3, the housing 25 extends to a position beneath the clerk-side display 22. As shown in FIG. 4, the housing 25 has a housing cavity 251 (or a cavity) on the store-clerk side (T side). That is, the housing cavity 251 is disposed on the same side as the clerk-side display 22. As shown in FIGS. 1 and 4, the housing cavity 251 can removably accommodate the printer 26. As shown in FIGS. 3 and 6, a surface of the housing 25 on the same side as the customer-side display 24 is coplanar with a surface of the upright part 27 to which the customer-side display 24 is attached.

In addition, the housing cavity 251 and the internal space of the upright part 27 are spatially connected to each other. The controller 16 inside the upright part 27 and the printer 26 inside the housing cavity 251 are connected to each other by a printer connection cable (for example, a power cable, a communication cable, or the like) within the internal space of the upright part 27 when the printer 26 is placed in the housing cavity 251.

In the present embodiment, when the printer 26 is not placed in the housing cavity 251, as illustrated in FIG. 5, the printer 26 is disposed such that an ejection port 261, from which a receipt is ejected, faces the customer side (C side). Specifically, as illustrated in FIG. 6, the printer 26 is disposed below the customer-side display 24 so as not to extend toward the customer side (C side) beyond the customer-side display 24 in the longitudinal direction. Thus, a printer mounting space for the

printer 26 is defined below the customer-side display 24 and in front of the surface of the housing 25 on the same side as the customer-side display 24.

Although not shown, at least one of the side surfaces and the back surfaces (or surfaces opposite the surfaces on the same side as the housing cavity 251) of the upright part 27 and the housing 25 has an opening for drawing the printer connection cable from the outside into the upright part 27. With this opening, even when the printer 26 is not placed in the housing cavity 251, the controller 16 and the printer 26 can be connected to each other. In other words, at least one of the housing 25 and the upright part 27 has an opening that permits the printer connection cable to pass therethrough to connect the controller 16 to the printer 26 when the printer 26 is disposed in the printer mounting space.

The printer 26 is, for example, a thermal printer that performs printing on a sheet fed from a sheet roll. The printer 26 is not limited to a thermal printer. For example, the printer 26 may be another type of printer, such as an inkjet printer or a wire dot printer.

The printer 26 has a width slightly smaller than the width of the housing cavity 251 at any position in the vertical direction so that the printer 26 can be accommodated in the housing cavity 251.

A stopper (not shown) may be provided in the housing cavity 251. The stopper prevents the printer 26 from being inserted deeper into the housing cavity 251 beyond the stopper. By adjusting the position of the stopper, the front end of the printer 26 placed in the housing cavity 251 can be aligned with the front end of the housing 25 in the longitudinal direction.

As shown in FIG. 4, when the printer 26 is not placed in the housing cavity 251, the housing cavity 251 is exposed. When dust and dirt enter the housing cavity 251, the operation of the POS terminal 1 may be affected. Therefore, when the printer 26 is not placed in the housing cavity 251, a lid (not shown) that closes the housing cavity 251 may be provided.

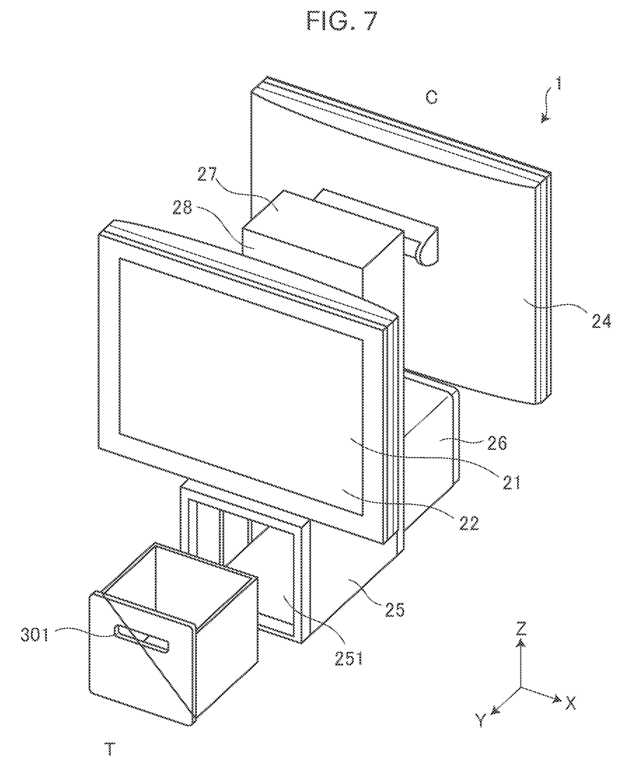

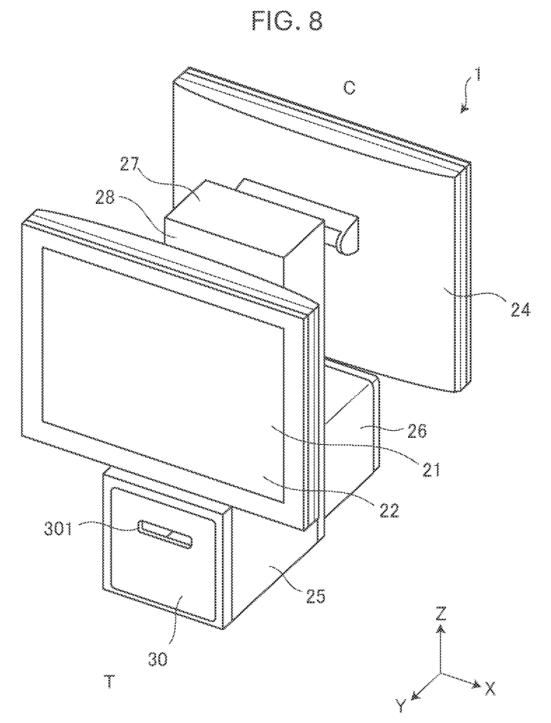

In addition, when the printer 26 is not placed in the housing cavity 251, the housing cavity 251 may accommodate a component other than the printer 26. For example, when the printer 26 is not placed in the housing cavity 251, the housing cavity 251 may accommodate a storage case 30 (see FIGS. 7 and 8). The storage case 30 is used to store, for example, a spare sheet roll (or receipt roll) and maintenance goods for the printer 26.

FIG. 7 is a diagram illustrating the storage case 30 before being inserted into the housing cavity 251. FIG. 8 is a diagram illustrating the storage case 30 inserted into the housing cavity 251. As shown in FIGS. 7 and 8, at any position in the vertical direction, the width of the storage case 30 is slightly smaller than the width of the housing cavity 251. Therefore, the storage case 30 can be accommodated in the housing cavity 251.

As shown in FIGS. 7 and 8, the storage case 30 has a finger hole 301. The store clerk can slide the storage case 30 in and out of the housing cavity 251 by inserting a finger into the finger hole 301.

In a case where the stopper is provided in the housing cavity 251, it is preferable that the length of the storage case 30 along the longitudinal direction of the POS terminal 1 is substantially the same as the length of the printer 26 along the longitudinal direction of the POS terminal 1. Accordingly, when the storage case 30 is placed in the housing cavity 251, the front end of the storage case 30 is aligned with the front end of the housing 25 in the longitudinal direction.

Although not shown in FIGS. 1-8, the POS terminal 1 includes a card reader 31 (see FIG. 9) and a code reader 32 (see FIG. 9).

The card reader 31 is used when non-cash payment is performed using a medium, such as a credit card. The card reader 31 has an insertion slot. The card reader 31 acquires information necessary for a payment process from the medium inserted into the insertion slot.

The code reader 32 has a reading window (not shown). The reading window is oriented toward the store clerk. When an item registration operation is performed by the store clerk by holding a code symbol over an area near the reading window, the code reader 32 reads the code symbol.

The POS terminal 1 may also include other components, such as a change machine used for cash payment, an electronic money reader/writer used by the customer for electronic money payment, and the like.

When an item registration operation is performed, the POS terminal 1 configured as described above performs an item registration process for registering items. In the item registration process, item information, such as item names and unit prices, of items in one transaction of the customer is read from an item master 122 (see FIG. 9) based on item codes of the items acquired through the item registration operation and is stored in an item information unit 131 (see FIG. 9).

Here, in the present embodiment, the POS terminal 1 acquires an item code from a code symbol when the item code is included in the code symbol or acquires an item code from a predetermined storage area based on a code symbol when the item code is not included in the code symbol.

The POS terminal 1 displays the item information of the items registered by the item registration process on the clerk-side display 22 and the customer-side display 24.

When a payment operation is performed by the customer, the POS terminal 1 performs a payment process for the items registered by the store clerk in the item registration process. In the payment process, the total amount of the items is displayed based on the item information stored in the item information unit 131 and is paid using cash or non-cash. The payment process includes a process of issuing a receipt by the printer 26.

Next, a hardware configuration of the POS terminal 1 will be described. FIG. 9 is a block diagram illustrating an example of a hardware configuration of the POS terminal 1 according to the embodiment. As shown in FIG. 9, the POS terminal 1 includes a CPU (Central Processing Unit) 11, which is an example of a processor, a ROM (Read Only Memory) 12, which is an example of a storage device, and a RAM (Random Access Memory) 13, which is an example of a memory.

The CPU 11 is the main controller. The ROM 12 stores various programs and various types of information. Note that a storage device, such as an HDD or an SSD, may be provided instead of or in addition to the ROM 12. Programs and various types of information are loaded into the RAM 13. The CPU 11, the ROM 12, and the RAM 13 are connected to each other via a bus 15.

The CPU 11, the ROM 12, and the RAM 13 constitute a control unit 100. That is, in the control unit 100, the CPU 11 operates according to a control program stored in the ROM 12 and loaded into the RAM 13 to perform a control process of the POS terminal 1, which will be described later.

The ROM 12 stores a control program unit 121 and an item master 122. The control program unit 121 stores a control program for operating the POS terminal 1. The item master 122 stores item information including item names, prices (or unit prices), and the like of items in association with item codes for identifying the items. The ROM 12 also stores a display information unit 123 including various types of information to be displayed on the clerk-side display 22 and the customer-side display 24 and a voice information unit 124 including various types of voice data to be output from a speaker (not shown).

The RAM 13 includes an item information unit 131 and a flag information unit 132. The item information unit 131 stores item information (item names, prices, etc.) of items that are registered in the item registration process based on item codes that are acquired based on code symbols read by the code reader 32.

The control unit 100 is connected to the clerk-side operation unit 21, the clerk-side display 22, the customer-side operation unit 23, the customer-side display 24, the printer 26, the card reader 31, and the code reader 32 via the bus 15 and the controller 16.

The controller 16 receives instructions from the control unit 100 and controls the clerk-side operation unit 21, the clerk-side display 22, the customer-side operation unit 23, the customer-side display 24, the printer 26, the card reader 31, and the code reader 32. In other words, the controller 16 controls these components under the control of the control unit 100 (or the CPU 11). For convenience of explanation, control performed by the controller 16 may be described as being performed by the control unit 100.

The clerk-side operation unit 21 is used by the store clerk to operate the POS terminal 1. The clerk-side operation unit 21 is, for example, a touch panel (or first touch panel) provided on the clerk-side display 22. For example, the store clerk performs an item registration operation by touching various keys displayed on the clerk-side display 22.

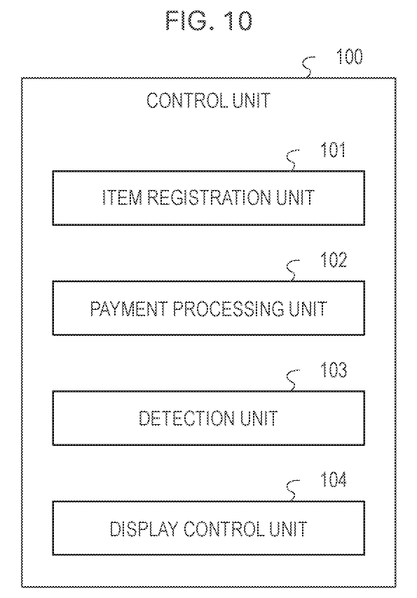

The clerk-side display 22 is, for example, a liquid crystal display, and displays item information and payment information for the store clerk. For example, when a detection unit 103 (see FIG. 10) determines that the printer 26 is disposed to face the store clerk side (T side), i.e., disposed in the housing cavity 251, the clerk-side display 22 displays a message prompting the store clerk to give a receipt to the customer while the receipt is being printed by the printer 26. This message may be referred to as a first message related to the receipt.

The customer-side operation unit 23 is used for the operation of the POS terminal 1 by the customer. The customer-side operation unit 23 is, for example, a touch panel (or second touch panel) provided on the customer-side display 24. For example, the customer performs a payment operation by touching various keys displayed on the customer-side display 24.

The customer-side display 24 is, for example, a liquid crystal display, and displays item information and payment information for the customer. For example, when the detection unit 103 (see FIG. 10) determines that the printer 26 is disposed to face the customer side (C side), i.e., disposed in the printer mounting space, the customer-side display 24 displays a message prompting the customer to take a receipt while the receipt is being printed by the printer 26. This message may be referred to as a second message related to the receipt.

The printer 26 prints item information and payment information of items for which the payment process has been performed. The printer 26 issues a receipt on which the item information and the payment information are printed.

The card reader 31 reads information used for a payment process from a medium, such as a credit card.

The code reader 32 is, for example, a scanner or a camera and reads a code symbol attached to each item.

The control unit 100 is connected to the communication unit 33 via the bus 15. The communication unit 33 is connected for communication to other POS terminals 1 and a store server (not shown) installed in the store via a communication line.

Hereinafter, a functional configuration of the POS terminal 1 will be described. FIG. 10 is a functional block diagram illustrating a functional configuration of the POS terminal 1 according to the embodiment. The control unit 100 of the POS terminal 1 functions as an item registration unit 101, a payment processing unit 102, a detection unit 103, and a display control unit 104 by executing a control program stored in the control program unit 121 of the ROM 12.

The item registration unit 101 performs an item registration process for registering items in response to an item registration operation performed by the store clerk and displays item information of the items registered by the item registration process on the customer-side display 24. To be specific, the store clerk causes the code reader 32 to read code symbols attached to items sold in the store, and the item registration unit 101 performs an item registration process to register the items based on the read code symbols and displays item information of the registered items on the customer-side display 24.

The payment processing unit 102 performs a payment process for items registered by the item registration process in response to a payment operation performed by the customer. The payment processing unit 102 displays payment information, which is the result of the payment process, on the customer-side display 24 and causes the printer 26 to issue a receipt on which the item information and the payment information are printed.

The detection unit 103 detects the orientation of the printer 26, that is, whether the printer 26 is disposed to face the store clerk side (T side) or the customer side (C side). For example, the orientation of the printer 26 is detected based on a signal (ON state or OFF state) from a contact sensor (not shown) provided in the housing cavity 251 of the housing 25. The contact sensor is an example of a detector.

Specifically, a protrusion (not shown) is provided on a side surface of the printer 26. The protrusion is an example of a detection part. The contact sensor is provided in the housing cavity 251 of the housing 25 so as to contact the protrusion when the printer 26 is placed in the housing cavity 251. In other words, the contact sensor is in the off state when the printer 26 is not placed in the housing cavity 251. When the printer 26 is placed in the housing cavity 251, the contact sensor contacts the protrusion of the printer 26 and transitions to the on state.

In addition, the contact sensor is disposed such that the contact sensor does not contact the storage case 30 when the storage case 30 is placed in the housing cavity 251 of the housing 25. This prevents the storage case 30 from being mistakenly detected as the printer 26.

Any known contact sensor may be used for the above purpose. For example, a contact sensor that senses pressure may be used. Alternatively, a mechanical switch may be used instead of the contact sensor. The mechanical switch is an example of a detector.

The mechanical switch is in the off state when the printer 26 is not placed in the housing cavity 251. When the printer 26 is placed in the housing cavity 251, the mechanical switch is pressed by the protrusion of the printer 26 and transitions to the on state (i.e., activated by the protrusion).

When the detector (contact sensor or mechanical switch) is in the on state, the detection unit 103 determines that the printer 26 is disposed to face the store clerk side (T side) or is placed in the housing cavity 251. On the other hand, when the contact sensor is in the off state (that is, when the printer 26 is not placed in the housing cavity 251), the detection unit 103 determines that the printer 26 is disposed to face the customer side (C side) or is placed in the printer mounting space.

The display control unit 104 displays a message related to the receipt on the clerk-side display 22 or the customer-side display 24 according to the detection result of the detection unit 103.

For example, when the detection unit 103 determines that the printer 26 is disposed to face the store clerk side (T side), the display control unit 104 causes the clerk-side display 22 to display a message (or first message) prompting the store clerk to give a receipt to the customer until a predetermined time elapses after payment is completed.

For example, when the detection unit 103 determines that the printer 26 is disposed to face the customer side (C side), the display control unit 104 causes the customer-side display 24 to display a message (or second message) prompting the customer to take a receipt until a predetermined time elapses after payment is completed.

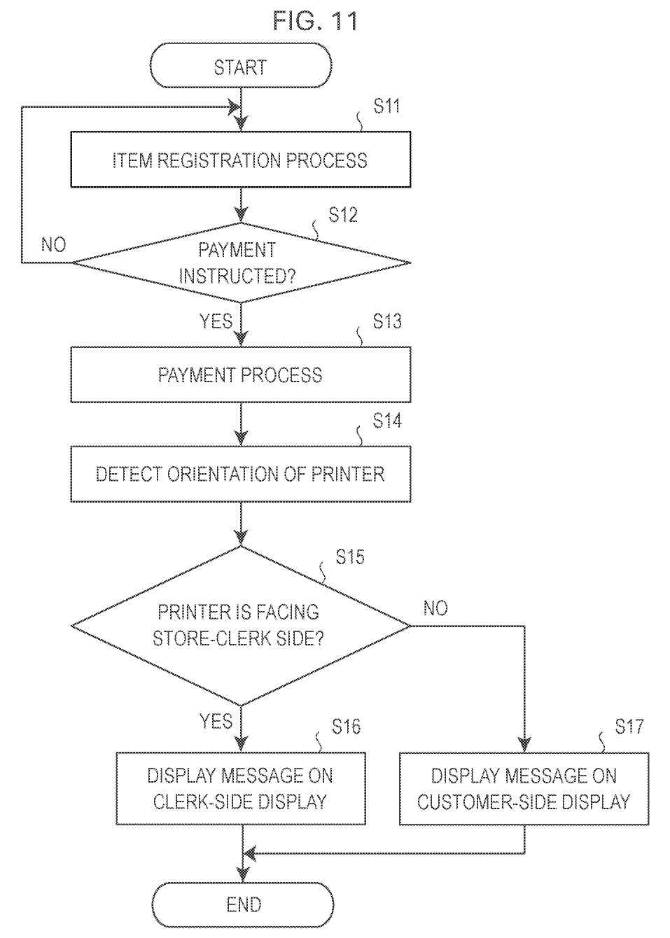

Next, a process performed by the POS terminal 1 will be described. FIG. 11 is a flowchart illustrating an example of a process performed by the POS terminal 1 according to the embodiment. The processor (or CPU 11) of the POS terminal 1 may be configured to execute a program stored in a memory (e.g., RAM 13) to perform the steps in the process described below.

First, the item registration unit 101 performs an item registration process (step S11). For example, the item registration unit 101 obtains item codes based on code symbols attached to items read by the code reader 32. The item registration unit 101 refers to the item master 122 and identifies item information corresponding to the item codes. The item registration unit 101 obtains the identified item information and stores the item information in the item information unit 131.

Next, the payment processing unit 102 determines whether an instruction to start a payment process has been received from the store clerk (step S12). For example, when the store clerk touches a payment key (not shown) displayed on the clerk-side display 22 to start a payment process, the payment processing unit 102 determines that the instruction to start the payment process has been received from the store clerk. When the instruction to start the payment process has not been received (step S12: No), the process returns to step S11.

On the other hand, when the instruction to start the payment process has been received (step S12: Yes), the payment processing unit 102 performs the payment process including the issuance of a receipt (step S13) based on the item information stored in the item information unit 131. For example, the payment processing unit 102 performs the payment process for the items registered in the item information unit 131 in accordance with a payment method selected by the customer. After the payment for the items registered in the item information unit 131 is completed, the payment processing unit 102 causes the printer 26 to print the item information and the payment information stored in the item information unit 131 on a receipt.

While the item information and the payment information are being printed, the detection unit 103 detects the orientation of the printer 26 (step S14). For example, when the contact sensor (or mechanical switch) is in the on state, the detection unit 103 determines that the printer 26 is disposed to face the store clerk side (T side) (or is placed in the housing cavity 251). On the other hand, when the contact sensor is in the off state, the detection unit 103 determines that the printer 26 is disposed to face the customer side (C side) (or is placed in the printer mounting space).

Next, the display control unit 104 determines whether the printer 26 is disposed to face the store clerk side (T side) based on the determination result of step S14 (step S15). When it is determined that the printer 26 is disposed to face the store clerk side (T side) (step S15: Yes), the display control unit 104 displays a message related to the receipt on the clerk-side display 22 (step S16) and ends the process.

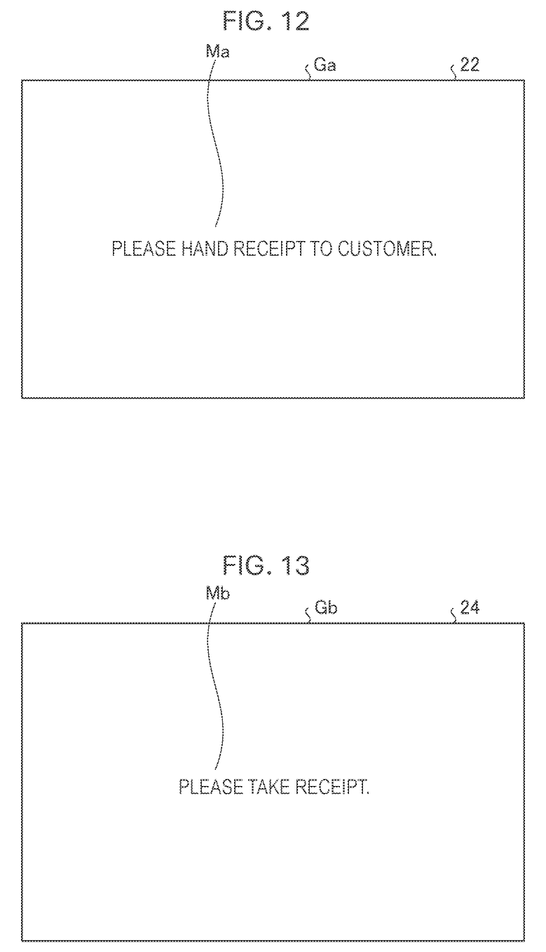

FIG. 12 is a diagram illustrating a display screen Ga of the clerk-side display 22. As illustrated in FIG. 12, the clerk-side display 22 displays a message Ma on the display screen Ga. The message Ma is for prompting the store clerk to give the receipt to the customer.

On the other hand, when it is determined that the printer 26 is disposed to face the customer side (C side) at step S15 (step S15: No), the display control unit 104 displays a message related to the receipt on the customer-side display 24 (step S16) and ends the process.

FIG. 13 is a diagram illustrating a display screen Gb of the customer-side display 24. As illustrated in FIG. 13, the customer-side display 24 displays a message Mb on the display screen Gb. The message Mb is for prompting the customer to take the receipt.

As described above, the POS terminal 1 according to the embodiment includes the printer 26 and the housing 25 having the housing cavity 251 that removably accommodates the printer 26.

Accordingly, when the printer 26 is placed in the housing cavity 251 of the housing 25, the printer 26 can be installed without using a space. Also, for example, since the printer 26 can be removed from the housing cavity 251, the printer 26 can be easily installed to face the customer side (C side). That is, the POS terminal 1 according to the present embodiment can improve the convenience of printer installation.

In addition, when the printer 26 is not placed in the housing cavity 251 of the housing 25, the POS terminal 1 can accommodate the storage case 30 in the housing cavity 251. For example, the storage case 30 can store a spare sheet roll and maintenance goods for the printer 26. With the storage case 30, the store clerk can efficiently replace the sheet roll and perform maintenance work of the printer 26.

The above embodiment can be modified as appropriate by changing some of the configurations or functions of the POS terminal 1. Hereinafter, variations of the above embodiment will be described as other embodiments. Below, features different from the above embodiment will be mainly described, and detailed descriptions of common features will be omitted. The variations described below may be implemented individually or in combination as appropriate.

### First Variation

In the above-described embodiment, the printer 26 is disposed on the customer side (C side) when the printer 26 is not placed in the housing cavity 251 of the housing 25. However, even when the printer 26 is not placed in the housing cavity 251 of the housing 25, the printer 26 may be disposed in any position other than the housing cavity 251 of the housing 25 on the store clerk side (T side).

In addition, in the present variation, when it is determined that the printer 26 is not placed in the housing cavity 251 of the housing 25, a user, such as the store clerk, may set whether to display a message prompting the user to take a receipt on the customer-side display 24.

According to the present variation, the convenience of printer installation can be further improved.

### Second Variation

In the above-described embodiment, both of the clerk-side display 22 and the customer-side display 24 are supported by one upright part 27. In the present variation, the customer-side display 24 is supported by a member different from the upright part 27.

In the present variation, the POS terminal 1 includes a second upright part (not shown) that is different from the upright part 27 and is positioned upright on the bagging counter. The customer-side display 24 of the present variation is provided on an upright surface of the second upright part on the customer side (C side) so as to be tiltable.

At least one of the side surfaces and the back surfaces of the upright part 27 and the housing 25 has an opening for drawing a customer-side display connection cable (for example, a power cable, a communication cable, or the like), which connects the controller 16 to the customer-side display 24, from the outside into the upright part 27.

The second upright part may have a cavity that accommodates at least a part of the printer 26. In this case, the cavity is preferably designed to be able to accommodate the printer 26 such that the printer 26 does not extend toward the customer side (C side) beyond the customer-side display 24 in the longitudinal direction.

The second upright part may have a hollow structure, and a part of the customer-side display connection cable may be accommodated in the second upright part.

According to the present variation, the physical load on the upright part 27 can be reduced.

In the above-described embodiment, the code reader 32 is used as a device for reading code symbols. However, the present disclosure is not limited to this example, and the device for reading code symbols may be a stationary scanner, a stationary camera, a handy scanner, or a handy camera.

Programs executed by the POS terminal 1 according to the embodiment may be provided on a computer-readable recording medium, such as a CD-ROM, a flexible disk (FD), a CD-R, or a digital versatile disc (DVD), in an installable or executable file format.

Programs executed by the POS terminal 1 according to the embodiment may be stored in a computer connected to a network, such as the Internet, and downloaded via the network. Programs executed by the POS terminal 1 of the embodiment may be provided or distributed via a network, such as the Internet.

Programs executed by the POS terminal 1 according to the embodiment may be stored in a ROM or the like in advance.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A sales data processing apparatus comprising:
a first display device;
a second display device;
a printer;
a housing having a cavity that is capable of removably accommodating the printer and is disposed on the same side as the first display device; and
a support column that is disposed on an upper surface of the housing and supports the first display device and the second display device in a back-to-back arrangement.

2. The sales data processing apparatus according to claim 1, further comprising:
a sensor disposed in the cavity of the housing;
a memory; and
a processor configured to execute a program that is stored in the memory to perform the steps of:
determining an orientation of the printer based on a signal from the sensor,
when the determined orientation corresponds to a first direction to which the first display device faces, controlling the first display device to display a first message, and
when the determined orientation corresponds to a second direction to which the second display device faces, controlling the second display device to display a second message.

3. The sales data processing apparatus according to claim 2, wherein
the printer includes a protrusion formed on a side surface of the printer; and
the sensor is a contact sensor and configured to output the signal upon contact with the protrusion.

4. The sales data processing apparatus according to claim 2, wherein
the printer includes a protrusion formed on a side surface of the printer; and
the sensor is a mechanical switch and configured to output the signal when activated by the protrusion.

5. The sales data processing apparatus according to claim 1, wherein
a printer mounting space for the printer is below the second display device and in front of a surface of the housing on the same side as the second display device.

6. The sales data processing apparatus according to claim 5, wherein
the printer is positionable in the printer mounting space such that the printer does not extend beyond the second display device.

7. The sales data processing apparatus according to claim 5, wherein
the printer has an ejection port through which a receipt is ejected;
the ejection port is oriented toward a first direction when the printer is placed in the cavity of the housing; and
the ejection port is oriented toward a second direction opposite the first direction when the printer is disposed in the printer mounting space.

8. The sales data processing apparatus according to claim 5, further comprising:
a controller disposed in an internal space of the support column and configured to control the first display device, the second display device, and the printer, wherein
the internal space of the support column and the cavity of the housing are spatially connected to each other; and
the controller is connected to the printer by a connection cable within the internal space of the support column when the printer is placed in the cavity of the housing.

9. The sales data processing apparatus according to claim 8, wherein
at least one of the housing and the support column has an opening that permits the connection cable to pass therethrough to connect the controller to the printer when the printer is disposed in the printer mounting space.

10. The sales data processing apparatus according to claim 1, wherein
a surface of the housing on the side where the second display device is arranged is coplanar with a surface of the support column to which the second display device is attached.

11. The sales data processing apparatus according to claim 1, wherein
the housing extends to a position beneath the first display device.

12. The sales data processing apparatus according to claim 1, further comprising:
a code reader configured to read a code symbol attached to an item.

13. The sales data processing apparatus according to claim 12, further comprising:
a storage device that stores an item master including item information of multiple items.

14. The sales data processing apparatus according to claim 1, wherein
the support column includes a first tilt mechanism and a second tilt mechanism;
the first display device is tiltable by the first tilt mechanism; and
the second display device is tiltable by the second tilt mechanism.

15. The sales data processing apparatus according to claim 1, wherein
the housing includes a stopper that is disposed in the cavity and prevents the printer from being inserted deeper into the cavity beyond the stopper.

16. The sales data processing apparatus according to claim 1, further comprising:
a storage case that is insertable into the cavity of the housing in place of the printer.

17. The sales data processing apparatus according to claim 16, wherein
a length of the printer along a longitudinal direction of the sales data processing apparatus is the same as a length of the storage case along the longitudinal direction of the sales data processing apparatus.

18. The sales data processing apparatus according to claim 1, further comprising:
a first touch panel that is disposed on the first display device and enables a first operator facing the first display device to perform an operation related to an item registration process; and
a second touch panel that is disposed on the second display device and enables a second operator facing the second display device to perform an operation related to a payment process.

19. A method for controlling a sales data processing apparatus, the apparatus including a first display device, a second display device, a printer, a housing with a cavity for accommodating the printer, and a sensor disposed in the cavity, the method comprising:
detecting, via the sensor, a signal associated with a position of the printer within the cavity;
determining an orientation of the printer based on the signal from the sensor;
displaying a first message on the first display device when the determined orientation corresponds to a first direction to which the first display device faces; and
displaying a second message on the second display device when the determined orientation corresponds to a second direction to which the second display device faces.

20. A non-transitory computer readable storage medium storing a program for causing a processor of a sales data processing apparatus to perform a process, the sales data processing apparatus including: a first display device, a second display device, a printer, a housing with a cavity for accommodating the printer, and a sensor disposed in the cavity, the process comprising:
detecting, via the sensor, a signal associated with a position of the printer within the cavity;
determining an orientation of the printer based on the signal from the sensor;
displaying a first message on the first display device when the determined orientation corresponds to a first direction to which the first display device faces; and
displaying a second message on the second display device when the determined orientation corresponds to a second direction to which the second display device faces.
